(19) United States
(12) Patent Application Publication
(10) Pub. No.: US 2025/0303794 A1
(43) Pub. Date: Oct. 2, 2025

(54) SUPPORT ASSEMBLY FOR A WHEEL END REDUCTION DRIVE

(71) Applicant: DANA ITALIA S.R.L., Arco (IT)

(72) Inventors: Francesco BROGGIO, Arco, Trento (IT); Claudio MAFFEI, Arco, Trento (IT); Davide DEIMICHEI, Arco, Trento (IT); Efrem RUSCONI, Arco, Trento (IT)

(21) Appl. No.: 19/096,529

(22) Filed: Mar. 31, 2025

(30) Foreign Application Priority Data
Apr. 1, 2024 (DE) 20 2024 101 583.5

(51) Int. Cl. B60B 35/12; B60K 1/00; B60K 17/04; B62D 7/18; F16H 1/28

(52) U.S. Cl. CPC B60B 35/125; B60K 1/00; B60K 17/046; B62D 7/18; F16H 1/28

(57) ABSTRACT

The present disclosure relates to a support assembly for a wheel end reduction drive, the support assembly comprising an axle member and a support member engaged with one another via a plurality of axially extending tooth members and recesses; to an axle assembly including said support assembly, and an epicyclic wheel end reduction drive supported on the support assembly; and to an electric vehicle including an electric motor, and said axle assembly, wherein the electric motor is drivingly engaged or drivingly engageable with the epicyclic wheel end reduction drive.

### CROSS REFERENCE TO RELATED APPLICATION

This application claims priority to German Utility Model Application No. 20 2024 101 583.5, entitled “SUPPORT ASSEMBLY FOR A WHEEL END REDUCTION DRIVE”, filed Apr. 1, 2024. The entire contents of the above-identified application is hereby incorporated by reference for all purposes.

### TECHNICAL FIELD

The present disclosure relates to a support assembly for a wheel end reduction drive, to an axle assembly comprising said support assembly, and to an electric vehicle.

### BACKGROUND AND SUMMARY

In many automotive vehicles, for example in electric vehicles, the drive shafts are coupled to the drive wheels via wheel end reduction drives which reduce a high rotational speed of the drive shafts to a lower rotational speed of the drive wheels. Often, a wheel end reduction drive includes an epicyclic or planet gear train. An epicyclic gear train typically includes a sun gear, a ring gear, a planetary carrier, and planet gears rotatably mounted on the planetary carrier, wherein the planet gears are drivingly engaged with or in mesh with the sun gear and with the ring gear. Epicyclic gear trains are commonplace in wheel end reduction drives due to their high degree of compactness.

A support assembly for supporting one or more of the sun gear, the ring gear and the planetary carrier of the epicyclic wheel end reduction drive usually includes an axle member, for example an axle housing or a steering knuckle, and a support member mounted on the axle member. Typically, the support member is mounted on the axle member via fastening members such as bolts. One of the sun gear, the ring gear and the planetary carrier of the epicyclic wheel end reduction drive may then be fixedly connected to or fixedly mounted on the support member.

In order to enhance the stability and longevity of the support assembly, the axle member and the support member may further be connected to one another via a splined connection. For example, the axle member may include a tube-like female section comprising a cylindrical inner surface having a plurality of radially inward facing splines formed therein.

And the support member may include a male section comprising a cylindrical outer surface having a plurality of radially outwardly facing splines formed therein. The male section of the support member is then typically received in the tube-like female section of the axle member, wherein the splines of the axle member and the splines of the support member engage one another to form a torque-proof connection between the axle member and the support member.

However, machining a splined connection between the axle member and the support member as described above usually requires a high degree of precision and dedicated, expensive tools. Consequently, the production of a support assembly of the above-described type may be labor-intensive and costly.

Thus, there is demand for a support assembly for an epicyclic wheel end reduction drive with an alternative torque-proof connection between an axle member and a support member which can be produced preferably easily and at preferably low cost.

This demand is met by a support assembly for an epicyclic wheel end reduction drive as described herein, by an axle assembly including said support assembly, and by an electric vehicle including said axle assembly.

The presently proposed support assembly for a wheel end reduction drive comprises an axle member, a support member, and a plurality of bolts extending in an axial direction and connecting the support member to the axle member. An axial end face of at least one of the axle member and the support member forms axially protruding tooth members, and an axial end face of at least the other of the axle member and the support member forms axially extending recesses. The axially protruding tooth members are received in the axially extending recesses, thereby forming a torque-proof connection between the axle member and the support member with respect to a rotation axis parallel to the axial direction.

Typically, the torque-proof connection between the axle member and the support member including the axially protruding tooth members received in the axially extending recesses can be manufactured more easily and at lower cost with respect to known support assemblies for wheel end reduction drives.

The axially protruding tooth members may be formed in one piece with the one of the axle member and the support member. For example, some or all of the axially protruding tooth members may be formed in one piece with the axle member. Additionally or alternatively, some or all of the axially protruding tooth members may be formed in one piece with the support member. Alternatively, it is conceivable that some or all of the tooth members are formed as separate pieces which are connected to the axial end face of either one or both of the axle member and the support member, for example via fastening members such as bolts. The tooth members and the recesses may be arranged symmetrically with respect to the rotation axis.

At least one of the plurality of bolts connecting the support member to the axle member may extend through one or more of the axially protruding tooth members.

The axle member and the support member may each feature an axially extending through hole aligned with the rotation axis and configured to receive a drive shaft therethrough. For instance, the axle member may comprise a tube-like spindle configured to support a wheel hub. The tube-like spindle may then feature an axially extending through hole as described above.

One or more contact faces of the tooth members configured to transmit and/or absorb torque between the support member and the axle member may extend in parallel to the axial direction. For example, the rotation axis may lie in a plane with one or more of the contact faces of the tooth members. In this way, the contact faces of the tooth members may efficiently transmit and/or absorb torque between the axle member and the support member.

The support member may be a ring gear carrier. Or in other words, the support member may be configured to be fixedly connected to a ring gear of the epicyclic wheel end reduction drive. The ring gear carrier may then be a gear-like member having a circular rim with radially outward facing teeth formed therein, for example. The radially outward facing teeth of the ring gear carrier may then be engaged with corresponding radially inward facing teeth of the ring gear, for example to provide a torque-proof connection between the ring gear carrier and the ring gear. However, it is likewise conceivable that in some embodiments the support member supports a planetary carrier of an epicyclic wheel end reduction drive. That is, in some embodiments the support member may be configured to be fixedly connected to a planetary carrier of an epicyclic wheel end reduction drive.

The axle member may be a steering knuckle. However, it is likewise conceivable that the axle member is or includes an axle housing, for example.

The presently proposed axle assembly comprises the previously described support assembly and an epicyclic wheel end reduction drive supported on the support assembly. For example, the epicyclic wheel end reduction drive may include an outer ring gear mounted on the support member. The outer ring gear may have a symmetry axis aligned with the rotation axis. The outer ring gear may comprise a plurality of radially inward facing teeth.

The axle assembly may further comprise a wheel hub rotatably supported on the axle member, and a drive shaft. The drive shaft may be coupled to the wheel hub via the epicyclic wheel end reduction drive. The epicyclic wheel end reduction drive may further include a sun gear which may be fixedly mounted on the drive shaft. Also, the epicyclic wheel end reduction drive may include a planetary carrier, and a plurality of planet gears rotatably mounted on the planetary carrier. The planetary carrier may be fixedly mounted on or fixedly connected to the wheel hub, for example. The planet gears may mesh with the sun gear and with the outer ring gear.

The presently proposed electric vehicle comprises an electric motor and the above-mentioned axle assembly. The electric motor may be drivingly engaged or drivingly engageable with the epicyclic wheel end reduction drive.

Embodiments of the presently proposed support assembly, axle assembly and electric vehicle are depicted in the accompanying drawing and are described in the following detailed description. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a perspective view of a support assembly according to a first embodiment.

FIG. 2 shows an axial cross section of a detail of the support assembly of FIG. 1.

FIG. 3A shows a perspective view of an axle member of the support assembly of FIG. 1.

FIG. 3B shows a perspective view of a support member of the support assembly of FIG. 1.

FIG. 4A shows a circumferential cross section of a detail of the support assembly of FIG. 1.

FIG. 4B shows a perspective view of elements of the support assembly of FIG. 1.

FIG. 5A shows a top view of an axle member according to a second embodiment.

FIG. 5B shows a perspective cut through the axle member of FIG. 5A and through tooth members of a support member engaged with the axle assembly.

FIG. 6A shows a top view of a support assembly according to a third embodiment.

FIG. 6B shows a perspective view of the support assembly of FIG. 6A.

FIG. 7A shows a perspective view of an axle member of the support assembly of FIG. 6A.

FIG. 7B shows a perspective view of a support member of the support assembly of FIG. 6A.

FIG. 8 shows an axial cross section of an axle assembly including the support assembly of FIG. 1.

FIG. 9A shows a perspective view of a support member and of a ring gear of the axle assembly of FIG. 8.

FIG. 9Bshows a perspective view of a planetary carrier of the axle assembly of FIG. 8.

FIG. 10 shows a perspective view of the axle assembly of FIG. 8.

FIG. 11 schematically shows an electric vehicle including the axle assembly of FIG. 8.

### DETAILED DESCRIPTION

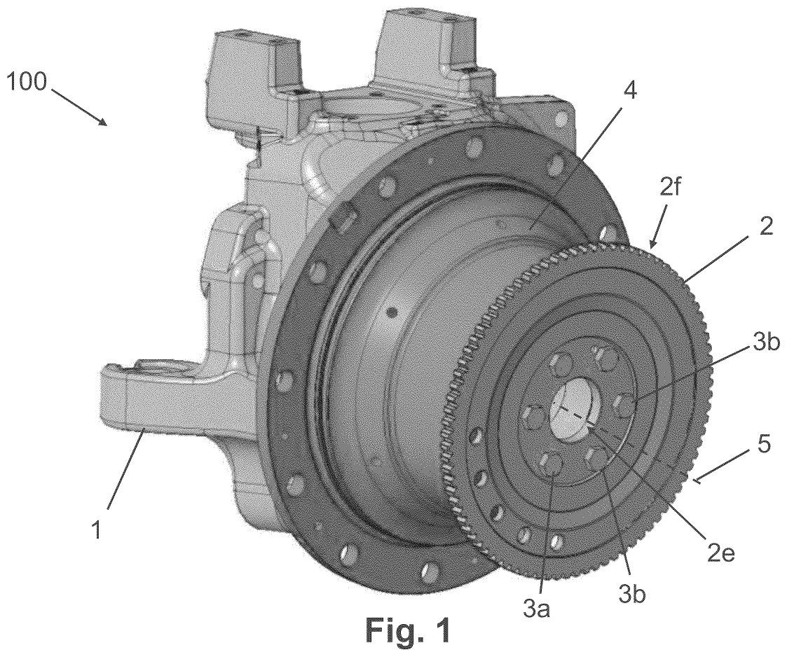

FIG. 1 illustrates a perspective view of a support assembly 100 of the presently proposed type according to a first embodiment. The support assembly 100 is configured to support a wheel end reduction drive for an automotive vehicle, for example an epicyclic wheel end reduction drive. The support assembly comprises an axle member 1, a support member 2, and a plurality of bolts 3a, 3b connecting the support member 2 to the axle member 1. FIG. 1 further illustrates a wheel hub 4 which is rotatably mounted on the axle member 1 and configured to rotate with respect to a rotation axis 5. The bolts 3a, 3b connecting the support member 2 to the axle member 1 extend in parallel to the rotation axis 5. In the embodiment depicted here, there is a total of six bolts 3a, 3b connecting the support member 2 to the axle member 1. The bolts 3a, 3b are arranged symmetrically with respect to the rotation axis 5. Only for illustrative purposes, not all of the bolts connecting the support member 2 to the axle member 1 are designated with reference signs. The axle member 1 and the support member 2 are stationary with respect to the rotation axis 5. Or in other words, the axle member 1 and the support member 2 are not configured to rotate with respect to the rotation axis 5.

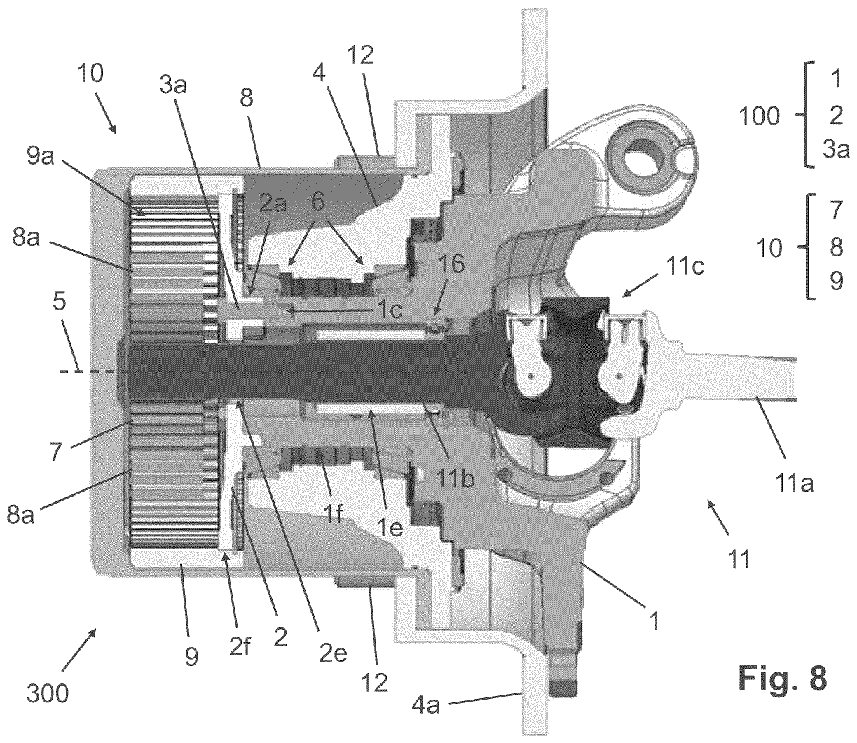

In the embodiment depicted in FIG. 1 the axle member 1 is a steering knuckle which, when mounted on a vehicle, is rotatable relative to a stationary vehicle chassis with respect to a steering axis. However, it is understood that in other embodiments not explicitly depicted here, the axle member 1 may include an axle housing, for example, which may be stationary with respect to a vehicle chassis. In the illustrated embodiment the support member 2 has an axially flat and laterally circular, disc-like or gear-like shape. Further, a circular outer rim of the support member 2 has a plurality radially outward facing gear teeth 2f, as will be further explained with respect to FIGS. 8 to 10 below. It is understood that in alternative embodiments a size and/or shape of the support member 2 may differ from the size and/or shape depicted in the figures and explicitly described herein.

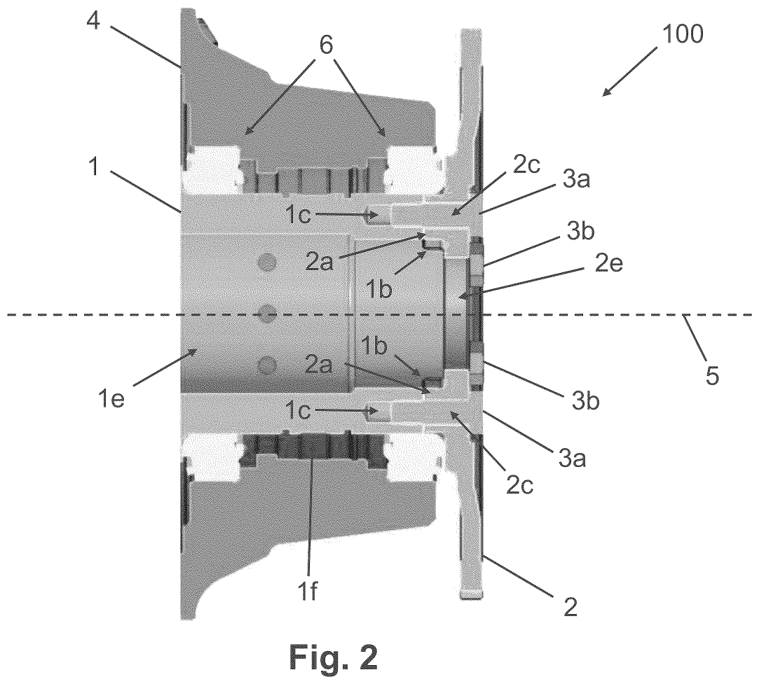

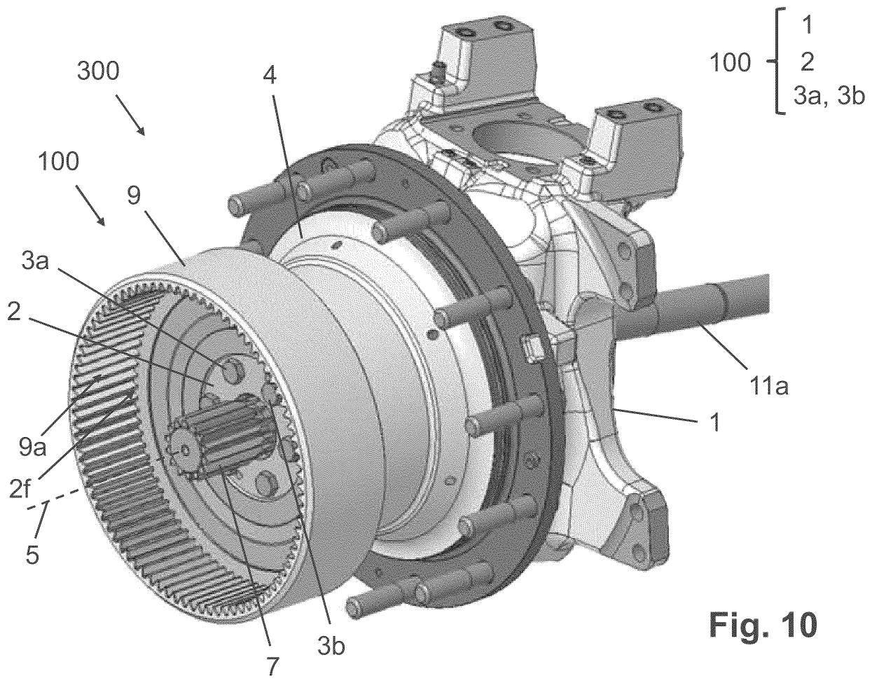

FIG. 2 shows a sectional view of a detail of the support assembly 100 of FIG. 1 wherein the sectional plane includes the rotation axis 5. Here and in all of the following, features recurring in different figures are designated with the same reference signs. The axle member 1 and the support member 2 feature axially extending through holes 1e, 2e, respectively, which are aligned with the rotation axis 5. The through holes 1e, 2e each have a cylindrical shape and are arranged symmetrically with respect to the rotation axis 5. As will be described with respect to FIGS. 8 and 10, the axially extending through holes 1e, 2e are configured to receive a drive shaft passing therethrough. The detail of the axle member 1 shown in FIG. 2 forms a tube-like spindle portion lf. The spindle portion If forms an axial end portion of the axle assembly 1 facing the support member 2. The wheel hub 4 is rotatably mounted on the spindle portion 1f by means of a bearing 6, for example a roller bearing. The bolts 3a, 3b connecting the support member 2 to the axle member 1 extend through axially extending borings 2c formed in the support member 2 and are received in corresponding axially extending borings Ic formed in the axle member 1. For example, the bolts 3a, 3b may have male threads which may be engaged with corresponding female threads formed in the borings 1c, 2c.

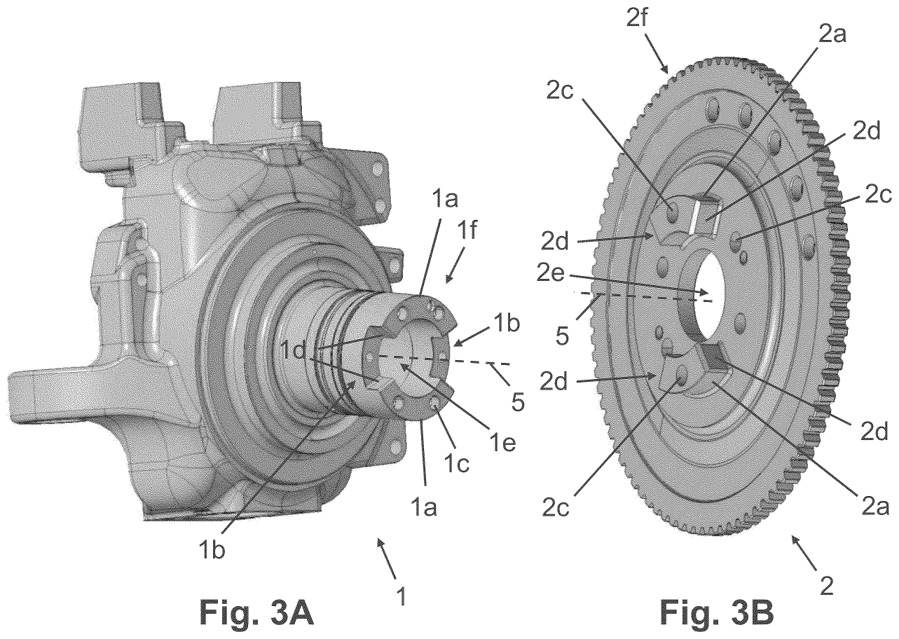

FIG. 3A and FIG. 3B feature perspective views of the axle member 1 and of the support member 2 of the support assembly 100 of FIGS. 1 and 2, respectively. As can be seen in FIG. 3A, an axial end face of the axle member 1 facing the support member 2, or, more specifically, an axial end face of the spindle portion 1f of the axle member I facing the support member 2, has been machined to form two recesses or cutouts 1b. In a circumferential direction, these recesses or cutouts 1b form two axially protruding tooth members 1a in the axial end face of the axle member 1 facing the support member 2, wherein the tooth members 1a are disposed in between the recesses or cutouts 1b. The recesses or cutouts 1b and the tooth members 1a are arranged symmetrically with respect to the rotation axis 5. In a lateral plane perpendicular to the rotation axis 5, both the two recesses or cutouts 1b and the two tooth members la are disposed diametrically opposite to one another, respectively. More specifically, in a lateral plane perpendicular to the rotation axis 5 the axially extending recesses or cutouts 1b have the shape of an intersection between the walls of the tubular spindle portion If with a sector of a circle whose centerpoint coincides with the rotation axis 5.

In the embodiment depicted here, in a circumferential direction perpendicular to the rotation axis 5 each of the recesses or cutouts 1b spans a circular sector of 60 degrees, while each of the tooth members 1a formed in between the recesses or cutouts 1b spans a circular sector of 120 degrees. Here, an axial depth of the recesses or cutouts 1b corresponds approximately to a radial thickness of the walls of the tubular spindle portion 1f of the axle member 1. An axial height of the tooth members la is given by the axial depth of the recesses or cutouts 1b formed therebetween. It is understood that in alternative embodiments the numbers of the recesses or cutouts 1b and of the tooth members 1a may be smaller or larger than two, and/or that in alternative embodiments the recesses or cutouts 1b and/or the tooth members la formed therebetween may have different shapes and/or different sizes or extensions. FIG. 3A further illustrates that some of the axially extending borings Ic extend from the recesses or cutouts 1b for receiving the bolts 3a, while others of the axially extending borings Ic extend through the tooth members la for receiving the bolts 3b.

FIG. 3B illustrates that an axial end face of the support member 2 facing the axle member 1 forms two axially protruding tooth members 2a. The tooth members 2a are sized and shaped to be received in the recesses or cutouts 1b formed in the axle member 1 in a form fit or positive fit, here in both the circumferential direction perpendicular to the rotation axis 5 and in an axial direction parallel to the rotation axis 5. In other words, a lateral or circumferential size and/or shape of the tooth members 2a of the support member 2 corresponds with a lateral or circumferential size and/or shape of the recesses or cutouts 1b of the axle member 1. And an axial height of the tooth members 2a of the support member 2 may correspond to the axial depth of the recesses or cutouts 1b formed in the axle member 1. In this way, when the tooth members 2a of the support member 2 are received or fully received in the recesses or cutouts 1b of the axle member 1, the tooth members 1a of the axle member 1 and the tooth members 2a of the support member 2 engage one another in a form fit, thereby providing a torque-proof connection or an additional torque-proof connection between the axle member 1 and the support member 2 with respect to the rotation axis 5.

In the illustrated embodiment, the support member 2 and the tooth members 2a axially protruding therefrom are made in one piece. However, it is understood that in alternative embodiments not explicitly depicted here, the support member 2 and the tooth members 2a may possibly be formed or made as separate pieces which are connected to one another, such as through bolts or rivets, by welding, or the like. FIG. 3B further illustrates that the axially extending through borings 2c formed in the support member 2 for receiving the bolts 3a, 3b extend both through the tooth members 2a and through areas disposed in between the tooth members 2a in a circumferential direction perpendicular to the rotation axis 5.

The tooth members 1a of the axle member 1 have axially extending contact faces 1d. Similarly, the tooth members 2a of the support member 2 have axially extending contact faces 2d. When the tooth members 2a of the support member 2 are received or fully received in the recesses or cutouts 1b of the axle member 1 and the tooth members 1a, 2a are engaged with one another to provide a torque-proof connection between the support member 2 and the axle member 1 with respect to the rotation axis 5, the tooth members 1a, 2a abut one another along the contact faces 1d, 2d so that torque may be transmitted or absorbed between the support member 2 and the axle member 1 via the contact faces 1d, 2d. In the embodiment depicted here, each of the contact faces 1d, 2d extends in parallel to the rotation axis. More specifically, each of the contact faces 1d, 2d lies in a plane which includes the rotation axis 5.

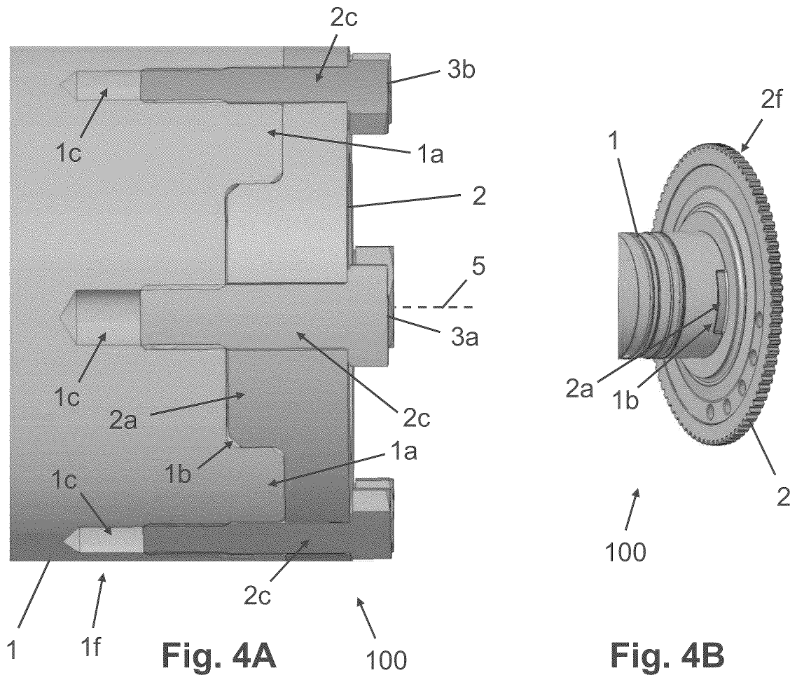

The axial cross section of FIG. 4A shows one of the tooth members 2a of the support member 2 received in one of the recesses or cutouts 1b formed in the axial end face of the spindle portion 1f of the axle member 1 in a form fit. The tooth members 2a of the support member 2 are engaged with the tooth members 1a of the axle member 1 to provide a torque-proof connection between the support member 1 and the axle member 1 with respect to the rotation axis 5. The axially extending bolts 3a, 3b connect the support member 2 to the axle member 1 in the axial direction parallel to the rotation axis 5. As can be seen in FIG. 4A, a bolt 3a extends through the tooth member 2a of the support member 2, and bolts 3b extend through tooth members la of the axle member 1. FIG. 4B shows a perspective view of this arrangement.

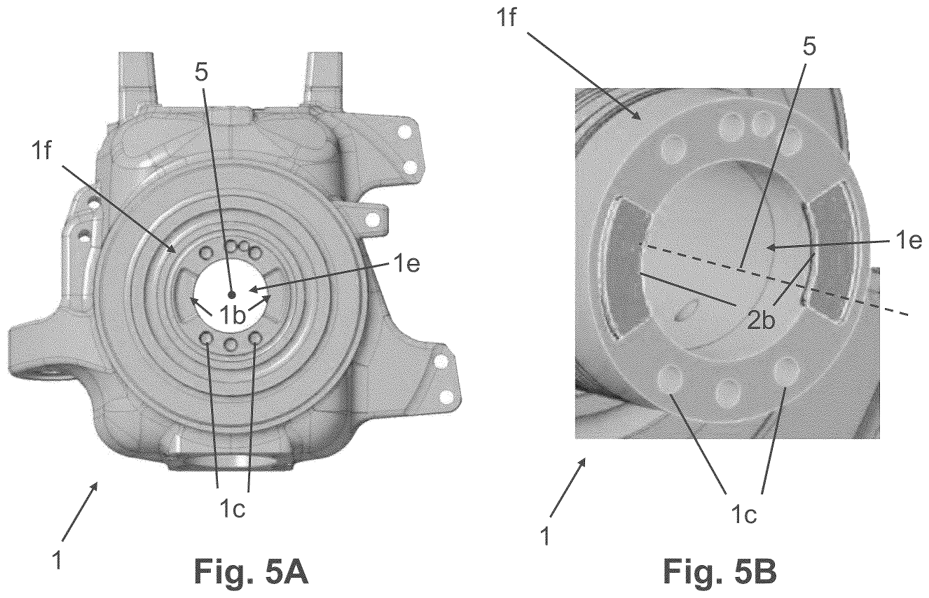

FIG. 5A and FIG. 5B depict the axial end face of the spindle portion If of the axle member 1 according to a slight variation of the embodiment illustrated in the previous figures. The embodiment shown in FIGS. 5A and 5B differs from the embodiment shown in the previous figures in that in FIGS. 5A and 5B the recesses or cutouts 1b formed in the axial end face of the spindle portion 1f do not extend all the way through the tubular walls of the spindle portion If in a radial direction perpendicular to the rotation axis 5. Rather, in FIGS. 5A and 5B a radially outer surface of an axial end portion of the spindle portion 1f facing the support member 2 has an entirely cylindrical shape. In this way, the radially outer surface of the spindle portion 1f may provide additional support for the bearing 6, for example (see FIG. 2).

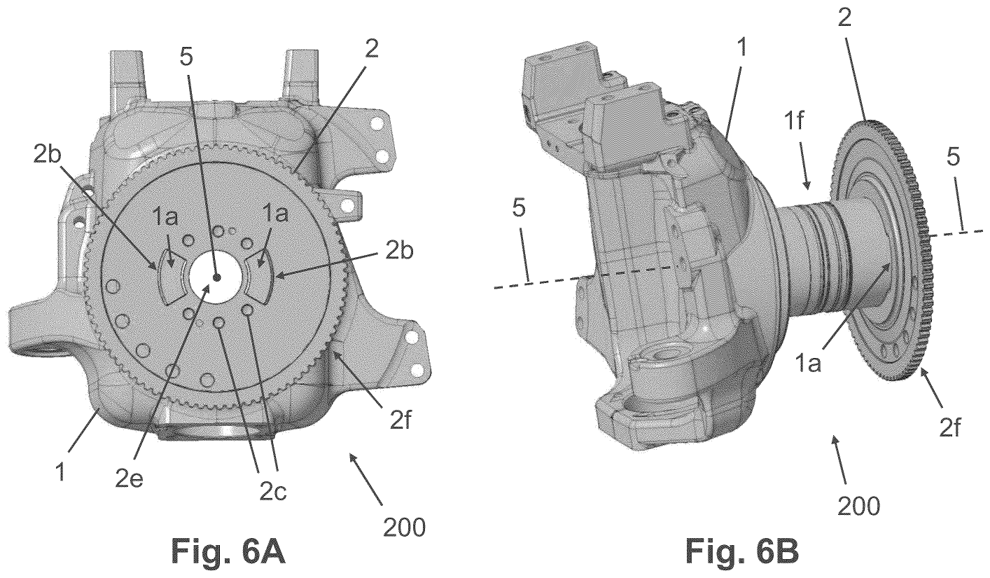

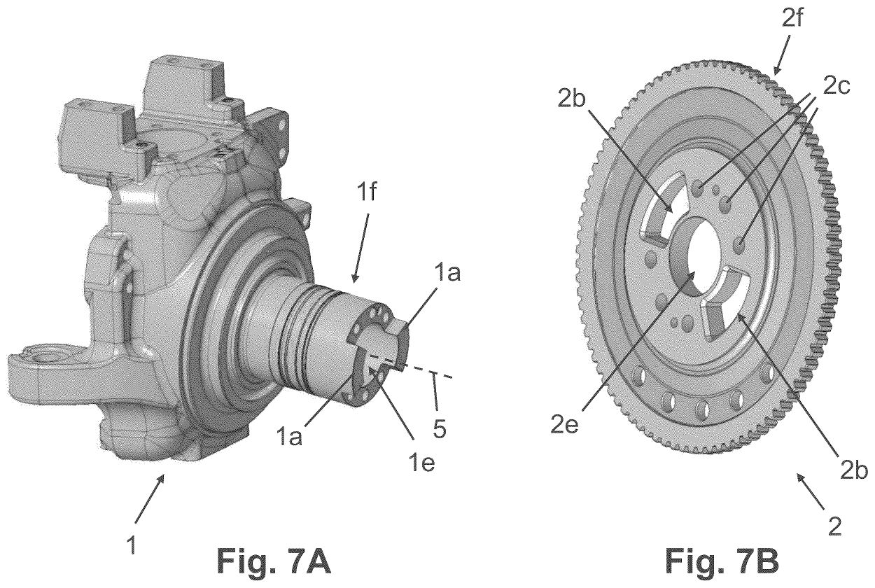

FIGS. 6A, 6B, 7A and 7B show the axle member 1 and the support member 2 of a support assembly 200 of the presently proposed type according to a second embodiment. As before, recurring features are designated with the same reference signs. For simplicity, only those features which distinguish the support assembly 200 of FIGS. 6A, 6B, 7A, 7B from the support assembly 100 illustrated in the previous figures will be explained in some detail. If not explicitly mentioned otherwise, the support assembly 200 may include the same features as the support assembly 100.

In contrast to the support assembly 100 of the previous figures, in the support assembly 200 of FIGS. 6A, 6B, 7A, 7B the support member 2 includes two additional recesses 2b. The recesses 2b are configured as through holes extending through the support member 2 in the axial direction parallel to the rotation axis 5. The recesses 2b are arranged, sized and shaped to receive the axially protruding tooth members 1a of the axle member 1 in a form fit. In other words, the recesses 2b are shaped as sections of a ring whose center point coincides with the rotation axis 5. Like the tooth members 1a of the axle member 1, the two recesses 2b formed in the support member 2 are arranged symmetrically with respect to the rotation axis 5 and are disposed diametrically opposed to one another with respect to the rotation axis 5. The recesses 2b are disposed at a distance from the axially extending central cylindrical through hole 2e formed in the support member 2. And further in contrast to the support assembly 100 of the previous figures, in the support assembly 200 of FIGS. 6A, 6B, 7A, 7B all of the axially extending through borings Ic formed in the axial end face of the spindle portion If of the axle member 1 for receiving the bolts 3b extend from the recesses or cutouts 1b formed in between the tooth members 1a.

Like in the support assembly 100 illustrated in the previous figures, when, in the support assembly 200 of FIGS. 6A, 6B, 7A, 7B, the tooth members la of the axle member 1 are received or fully received in the recesses 2b formed in the support member 2, the support member 2 and the axle member 1 engage one another in a form fit or positive fit. This form fit or positive fit between the support member 2 and the axle member 1 forms a torque-proof connection or an additional torque-proof connection between the support member 2 and the axle member 1 with respect to the rotation axis 5.

FIG. 8 shows a sectional view of an axle assembly 300 of the presently proposed type, wherein the sectional plane includes the rotation axis 5. As before, recurring features are designated with the same reference signs. The axle assembly 300 includes the support assembly 100 depicted in FIGS. 1, 2, 3A, 3B, 4A, 4B, the wheel hub 4 mounted on the spindle portion 1f of the axle member 1 via the bearing 6, a drive shaft 11, and an epicyclic wheel end reduction drive 10 coupling the drive shaft 11 to the wheel hub 4, thereby allowing the drive shaft 11 to drive a wheel mounted on the wheel hub 4, for example via a hub flange 4a mounted on the wheel hub 4. It is understood that in alternative embodiments not explicitly depicted here, the axle assembly 300 may alternatively include the support assembly 100 according to the variation depicted in FIGS. 5A and 5B, or the support assembly 200 according to FIGS. 6A, 6B, 7A, 7B. The drive shaft 11 includes a first drive shaft portion 11a and a second drive shaft portion 11b connected to one another through a double universal joint (DUJ) 11c. The second drive shaft portion 11b is rotatable with respect to the rotation axis 5 and is received in and extends through the through holes 1e, 2e formed in the axle member 1 and in the support member 2, respectively. The second drive shaft portion 11b is supported on the axle member 1 by means of a bearing 16.

The epicyclic wheel end reduction drive 10 includes a sun gear 7, a planetary carrier 8 having a plurality of planet gears 8a rotatably mounted thereon, and an outer ring gear 9 which is fixedly mounted on the support member 2 of the support assembly 100. In other words, in the embodiments depicted in the figures, the support member 2 is configured as a ring gear carrier. It is understood that in alternative embodiments not explicitly depicted here, the support member 2 may possibly be connected to or support another element of a wheel end reduction drive or of an epicyclic wheel end reduction drive such as a planetary carrier, for example.

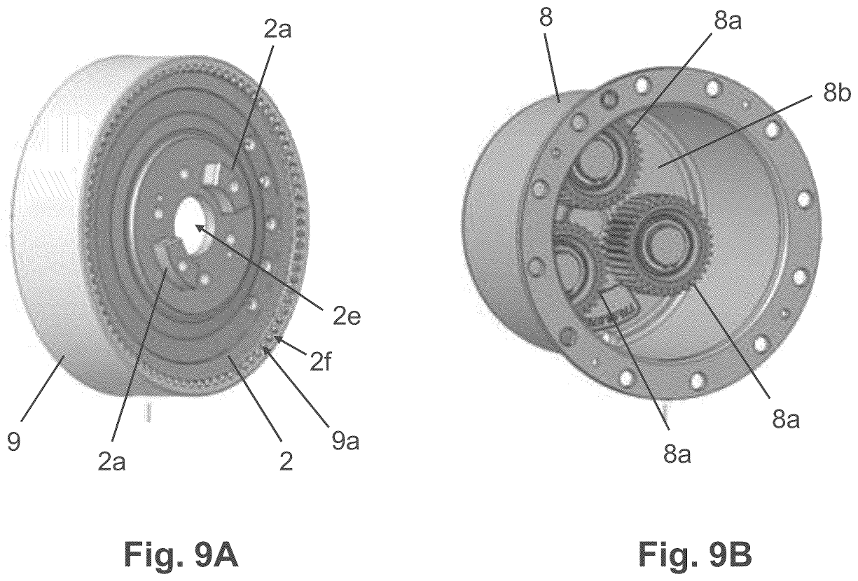

Further details of some of the elements of the epicyclic wheel end reduction drive 10 can be observed in FIGS. 9A, 9B and 10. The sun gear 7 is fixedly mounted on an axial end of the second drive shaft portion 11b, see FIG. 10. A rotation axis of the sun gear 7 coincides with the rotation axis 5. The planetary carrier 8 is configured as a cylindrical hub case fixedly connected to the wheel hub 4 via axially extending bolts 12. A symmetry axis of the cylindrical hub case forming the planetary carrier 8 coincides with the rotation axis 5. The sectional view of FIG. 8 illustrates that the outer ring gear 9 is disposed within the hub case forming the planetary carrier 8. Or in other words, in a radial direction perpendicular to the rotation axis 5, the hub case forming the planetary carrier 8 encloses the outer ring gear 9. As can be observed in FIG. 9B, the planet gears 8a are rotatably mounted on an inner side of an axial end wall 8b of the planetary carrier 8. The axial end wall 8b of the planetary carrier 8 is arranged perpendicular to the rotation axis 5.

A symmetry axis of the circular outer ring gear 9 coincides with the rotation axis 5. As can be more clearly observed in FIGS. 9A and 10, the outer ring gear 9 includes radially inward facing gear teeth 9a formed in a radially inner side of the outer ring gear 9. The gear teeth 9a of the outer ring gear 9 extend in parallel to the rotation axis 5. The radially inward facing gear teeth 9a of the outer ring gear 9 are engaged with the radially outward facing gear teeth 2f formed at the circular outer rim of the support member 2, thereby providing a torque-proof connection between the outer ring gear 9 and the support member 2 with respect to the rotation axis 5.

In the axle assembly 300 depicted in FIG. 8, the planet gears 8a are in mesh with the sun gear 7 and with the gear teeth 9a of the outer ring gear 9. As the axle assembly 1, the support member 2 and the outer ring gear 9 are stationary with respect to the rotation axis 5, the planetary carrier 8 is fixedly connected to the wheel hub 4, and the planet gears 8a are rotatably mounted on the planetary carrier 8, the rotating drive shaft 11 transmits torque to the wheel hub 4 via the epicyclic wheel end reduction drive 10. When the drive shaft 11 drives the wheel hub 4, the drive shaft 11, the sun gear 7, the planetary carrier 8 and the wheel hub 4 rotate with respect to the rotation axis 5.

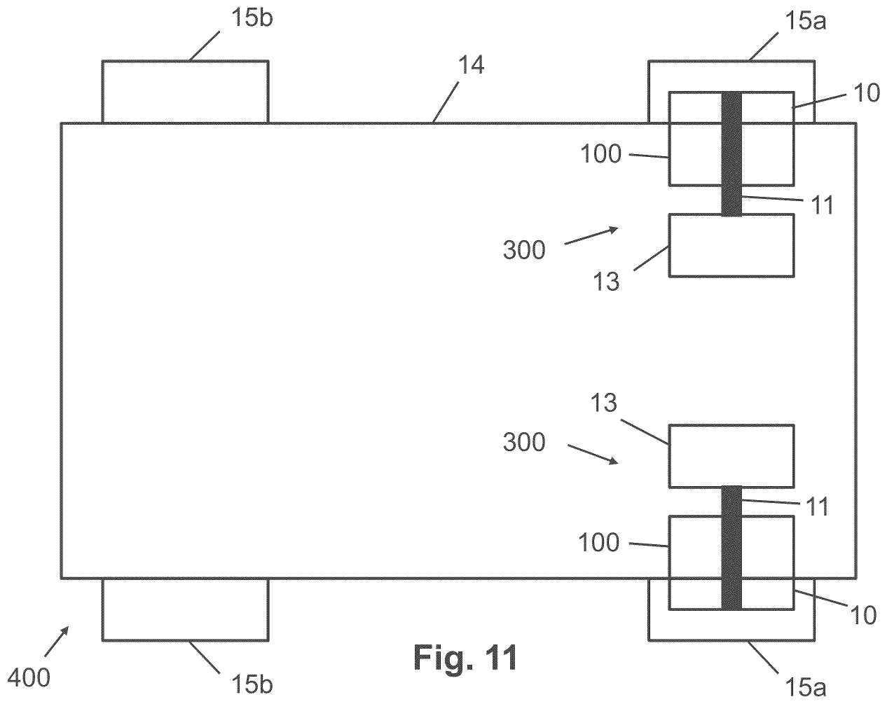

FIG. 11 schematically illustrates an electric vehicle 400 including two electric motors 13, two axle assemblies 300 of the type illustrated in FIGS. 8, 9A, 9B and 10 and described above, drive wheels 15a, and further wheels 15b. Each of the electric motors 13 is drivingly engaged or drivingly engageable with one of the two drive wheels 15a via one of the axle assemblies 300. Each of the axle assemblies 300 includes a drive shaft 11, an epicyclic wheel end reduction drive 10, and a support assembly 100 mounted on a vehicle chassis 14.

FIGS. 1-10 are shown approximately to scale. FIGS. 1-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another clement or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

### LIST OF REFERENCE SIGNS

1 axle member
1a tooth members
1b recesses
1c borings
1d contact face of 1a
1e through hole
1f spindle portion
2 support member
2a tooth members
2b recesses
2c borings
2d contact face of 2a
2e through hole
2f gear teeth
3a, 3b bolts
4 wheel hub
5 rotation axis
6 bearing
7 sun gear
8 planetary carrier
8a planet gears
9 ring gear
9a gear teeth
10 epicyclic wheel end reduction drive
11 drive shaft
1a first shaft portion
11b second shaft portion
11c joint
12 bolts
13 electric motor
14 vehicle chassis
15a drive wheels
15b further wheels
16 bearing
100 support assembly
200 support assembly
300 axle assembly
400 electric vehicle

1. A support assembly for a wheel end reduction drive, the support assembly comprising:
an axle member,
a support member, and
a plurality of bolts extending in an axial direction and connecting the support member to the axle member,
wherein an axial end face of one of the axle member and the support member forms axially protruding tooth members, and an axial end face of the other of the axle member and the support member forms axially extending recesses, wherein the axially protruding tooth members are received in the axially extending recesses, thereby forming a torque-proof connection between the axle member and the support member with respect to a rotation axis parallel to the axial direction.

2. The support assembly of claim 1, wherein the axially protruding tooth members are formed in one piece with the one of the axle member and the support member.

3. The support assembly of claim 2, wherein the axially protruding tooth members are connected to or formed in one piece with the axle member.

4. The support assembly of claim 2, wherein the axially protruding tooth members are connected to or formed in one piece with the support member.

5. The support assembly of claim 1, wherein at least one of the plurality of bolts extends through one of the axially protruding tooth members.

6. The support assembly of claim 1, wherein the axle member and the support member each feature an axially extending through hole aligned with the rotation axis and configured to receive a drive shaft therethrough.

7. The support assembly of claim 1, wherein the axle member comprises a tube-like spindle portion configured to support a wheel hub.

8. The support assembly of claim 1, wherein the axially protruding tooth members and the axially extending recesses are arranged symmetrically with respect to the rotation axis.

9. The support assembly of claim 1, wherein one or more contact faces of the axially protruding tooth members configured to transmit or absorb torque between the support member and the axle member extend in parallel to the rotation axis.

10. The support assembly of claim 9, wherein the rotation axis lies in a plane with one or more of the one or more contact faces of the axially protruding tooth members.

11. The support assembly of claim 1, wherein the support member is a ring gear carrier.

12. The support assembly of claim 11, wherein the ring gear carrier is a gear-like member having a toothed radially outer rim.

13. The support assembly of claim 1, wherein the axle member is a steering knuckle.

14. An axle assembly, comprising:
the support assembly of claim 1, and
an epicyclic wheel end reduction drive supported on the support assembly.

15. The axle assembly of claim 14, wherein the epicyclic wheel end reduction drive includes an outer ring gear mounted on the support member, the outer ring gear having a symmetry axis aligned with the rotation axis and comprising a plurality of radially inward facing gear teeth.

16. The axle assembly of claim 14, further comprising a wheel hub rotatably supported on the axle member, and a drive shaft, wherein the drive shaft is coupled to the wheel hub via the epicyclic wheel end reduction drive.

17. The axle assembly of claim 16, wherein the epicyclic wheel end reduction drive includes a sun gear fixedly mounted on the drive shaft.

18. The axle assembly of claim 16, wherein the epicyclic wheel end reduction drive includes a planetary carrier fixedly mounted on the wheel hub, and a plurality of planet gears rotatably mounted on the planetary carrier.

19. The axle assembly of claim 15, wherein the epicyclic wheel end reduction drive includes a sun gear fixedly mounted on the drive shaft, wherein the epicyclic wheel end reduction drive includes a planetary carrier fixedly mounted on the wheel hub, and a plurality of planet gears rotatably mounted on the planetary carrier, and wherein the plurality of planet gears mesh with the sun gear and with the outer ring gear.

20. An electric vehicle, comprising: an electric motor, and
the axle assembly of any one of claim 14,
wherein the electric motor is drivingly engaged or drivingly engageable with the epicyclic wheel end reduction drive.
